(19) United States
(12) Patent Application Publication
(10) Pub. No.: US 2005/0225810 A1
(43) Pub. Date: Oct. 13, 2005

(54) Image retrieval and memory-accessing business card scanning device

(76) Inventor: Fang Cheng Sun, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/815,733

(22) Filed: Apr. 2, 2004

(51) Int. Cl. H04N 1/04

(52) U.S. Cl. 358/474

(57) ABSTRACT

An image retrieval and memory-accessing business card scanning device has a housing with a accommodating space, an image retrieval unit set in a side of the device, a process unit for handling a plurality of pictures taken by an image retrieval unit, a memory expansion slot set in one side of the housing, a memory card set in the memory expansion slot to store a plurality of text images and pictures, a scanning unit set in the accommodating space to scan text information on a business card, and an image retrieval button set in one side of the housing as a switch for starting the image retrieval process. By plugging a business card into the business card entrance, the text information on the business card will be scanned and transformed into image data. The device can also take pictures for combination with the business cards.

### BACKGROUND OF THE INVENTION

1. Field of the Invention

The present invention is an image retrieval and memory-accessing business card scanning device. The present invention relates to a business card scanning device for editing a plurality of text information on a business card with pictures taken by an image retrieval unit for further editing.

2. Description of Related Art

Nowadays, it is obvious that everyone in companies has a business card to introduce his company or himself. The following problem is that it is hard to manage the business cards when receiving too many of them. Therefore, there is a trend to transform the business cards into image data and store the data in hard disks of computers or other memory devices. Many related scanning devices are invented and the text information on the business cards is scanned and stored into some memory devices for managing the data conveniently.

Reference is made to FIG. 1, which shows a prior art business card scanner comprising a business card input slot 11, a business card output slot 12, a scanning switch 13, and a connecting cord 14.

Many related business card scanning devices are invented for managing business cards and transforming the business cards into image data. When a user has too many business cards with only text information thereon, it will be difficult to identify every client and the name of his company clearly. The above-mentioned prior art technique cannot deal with such a problem. Due to the reason, an image retrieval and memory-accessing business card scanning device is proposed in the present invention.

### SUMMARY OF THE INVENTION

The object of the present invention is to provide an image retrieval and memory-accessing business card scanning device. The present invention can scan the business cards and then store the scanned data in a memory card. An image retrieval unit can take pictures and store the pictures in the memory card, and combine the pictures with the scanned data of the business cards.

The present invention integrates text information with taken pictures into one business card, and then text information and pictures can be edited on a computer. The present invention provides a scanning device with image retrieval and memory-access functions, and the scanning device comprises a housing with a accommodating space, an image retrieval unit set on a side of the scanning device, a process unit dealing with a plurality of pictures taken by the image retrieval unit, a memory expansion slot set in one side of the housing, a scanning device set in the accommodating space, and an image retrieval button set on one side of the housing as a switch for starting the image retrieval process. A business card entrance and a business card exit are in the housing and communicate with the accommodating space; and a memory card can be inserted in the memory card slot to store a plurality of pictures and text information.

### BRIEF DESCRIPTION OF THE DRAWINGS

The various objects and advantages of the present invention will be more readily understood from the following detailed description when read in conjunction with the appended drawings, in which:

FIG. 1 shows the prior art business card scanner;

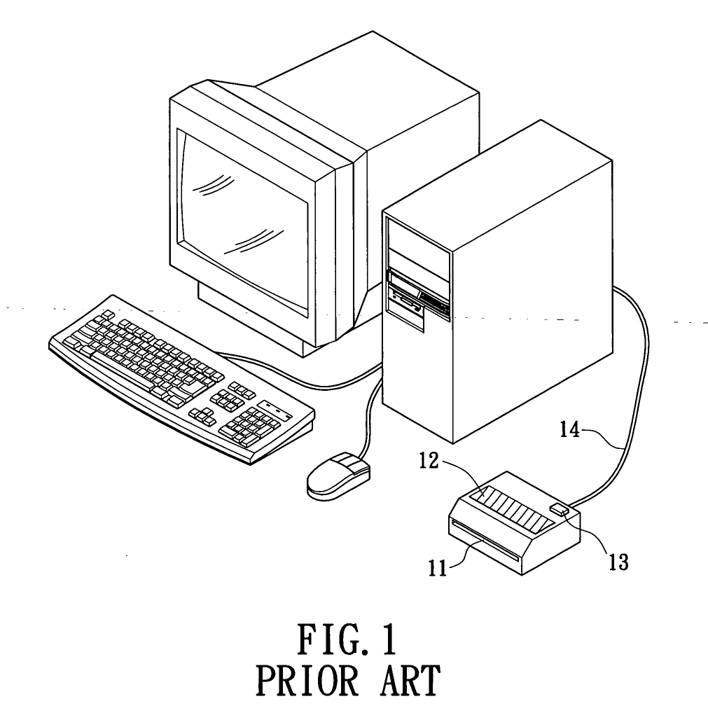

FIG. 2 shows a perspective view of the present invention;

FIG. 3 shows a preferred embodiment according to the present invention; and

FIG. 4 shows a schematic view of a system in the present invention.

### DETAILED DESCRIPTION OF PREFERRED EMBODIMENTS

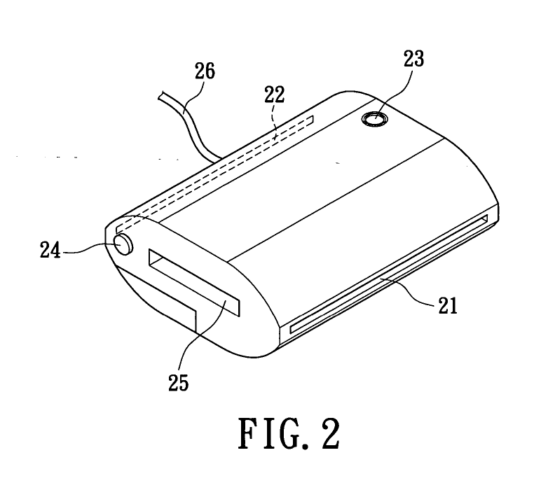

FIG. 2 shows the perspective view of the business card scanning device according to the present invention. The business card scanning device comprises a housing with an accommodating space therein, a business card entrance 21 and a business card exit 22 set in the housing and communicating with the accommodating space, an image retrieval unit 23 set in a side of the scanning device, a process unit (not shown) for handling a plurality of pictures taken by the image retrieval unit 23, a scanning unit (not shown) set in the accommodating space to scan the text information on the business card, a memory expansion slot 25 set in one side of the housing and a button 24 set in the same side of the housing as a switch for starting the image retrieval process. A memory card can be set in the memory card expansion slot 25 to store a plurality of pictures and text information.

When a user plugs a business card into the business card entrance 21, the text information on the business card will be scanned and transformed in to image data. The data are stored into a memory card in the memory card expansion slot 25. Finally, the card is output from the business card output exit 22. The memory card can be a CF (compact flash) card, a MS (Memory Stick) card, a MM (Multimedia) card, or a SD (smart media) card.

During the scanning process, the user can press the button 24 to take the pictures of the business card's owner with the image retrieval unit 23.

The user can edit the text information on the business card with the taken pictures by an appended application program. At the same time, an address book function can be added as another application program.

The data in the memory card is transferred to a computer by a connecting cord 26 and users can edit the data conveniently. The connecting cord 26 can be a USB connecting cord or an IEEE 1394 bus connecting cord.

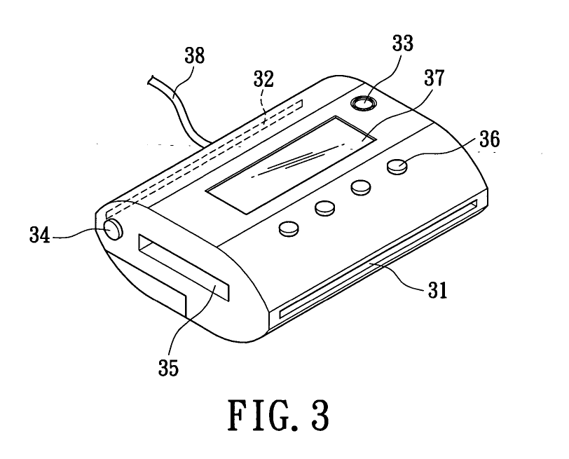

FIG. 3 is a preferred embodiment of the present invention. The device comprises a housing with a accommodating space in it, a business card entrance 31 and a business card exit 32 set in the housing and communicating with the accommodating space, an image retrieval unit 33 set in a side of the scanning device, a process unit (not shown) dealing with a plurality of pictures taken by the image retrieval unit 33, a scanning unit (not shown) set in the accommodating space to scan the text information on the business card, an image retrieval button 34 set in one side of the housing as a switch for starting the image retrieval process, a screen 37 set on the top of the housing to display the text information and pictures stored in the memory card, a plurality of operation buttons 36 set in the top of the housing for editing the text images and pictures stored in the memory card, and a connecting cord 38 to transfer the text images and pictures to the computer. A memory card can be set in the memory card expansion slot 35 to store a plurality of pictures and text information.

When a user plugs a business card into the business card entrance 31, the text information on the business card will be scanned and transformed in to image data. The data are stored into a memory card in the memory card expansion slot 35. Finally, the card is output from the business card output exit 32. The memory card can be a CF (compact flash) card, a MS (Memory Stick) card, a MM (Multimedia) card, or a SD (smart media) card.

During the scanning process, the user can press the image retrieval button 34 to take pictures of the business card's owner by the image retrieval unit 33.

The user can edit the text information on the business card with the taken pictures by an appended application program. At the same time, an address book function can be added.

The data in the memory card is transferred to a computer by a connecting cord 38 and users can edit the data conveniently. The connecting cord 38 can be a USB connecting cord or an IEEE 1394 bus connecting cord.

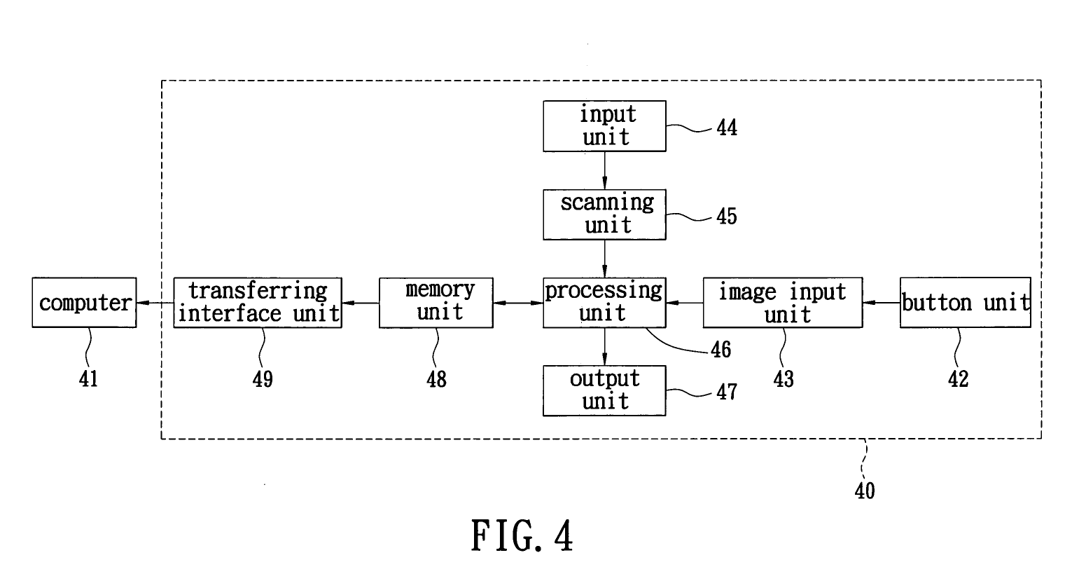

FIG. 4 shows a schematic view 40 of the present invention, comprising a button unit 42, an image input unit 43, an input unit 44, a scanning unit 45, a processing unit 46, an output unit 47, a memory unit 48, a transferring interface unit 49 and a computer 41.

When the user puts the business card into the input unit 44, the business card will be scanned by the scanning unit 45. The scanned text images are transferred to the processing unit 46 and stored in the memory unit 48. Finally, the business card will be output from the output unit 47. The memory unit 48 can be a CFC (Compact Flash Card), a MS (Memory Stick), a MMC (Multimedia Card), a SDC (Secure Digital Card) or a SMC (Smart Media Card).

The image input unit 43 can take the pictures by pressing the button unit 42. The pictures are processed by the processing unit 46 and stored in the memory unit 48.

Users can also transfer the text images and pictures stored in the memory unit 48 to the computer 41 through transferring interface unit 49. The transferring interface unit 49 can be a USB interface or an interface with an IEEE 1394 bus.

Therefore, there are several advantages of the present invention as follows:
1. A business card can be inserted to an input unit and scanned as image data by a scanning unit. The image data is then stored in a memory unit. Such process simplifies the complexity of business card management.
2. An image retrieval unit can take a plurality of pictures and store the pictures into the memory unit.
3. An appended application program can edit the text on the business card with the taken pictures and an address book function can be added.
4. A transferring interface unit may access a plurality of text images and pictures in the memory unit through a connecting cord. The text images and pictures can also be transferred to the computers for advanced editing.

Although the present invention has been described with reference to the preferred embodiment therefore, it will be understood that the invention is not limited to the details thereof. Various substitutions and modifications have suggested in the foregoing description, and other will occur to those of ordinary skill in the art. Therefore, all such substitutions and modifications are intended to be embrace within the scope of the invention as defined in the appended claims.

1. An image retrieval and memory-accessing business card scanning device, comprising:
a housing with an accommodating space, a business card entrance and a business card exit set in the housing and communicating with the accommodating space;
an image retrieval unit set in one side of the device;
a process unit dealing with a plurality of pictures taken by the image retrieval unit;
a memory expansion slot set in one side of the housing, a memory card being set in the memory expansion slot to store a plurality of pictures and text information;
a scanning unit set in the accommodating space to scan text on a business card; and
an image retrieval button set in one side of the housing as a switch for starting the image retrieval process;
wherein by plugging a business card into the business card entrance, the text on the business card is scanned and transformed into image data, and the data is stored in the memory card, while by pressing the button, pictures of people are taken for combination with the business cards.

2. The image retrieval and memory-accessing business card scanning device as in claim 1, wherein the memory card is one of a CFC (Compact Flash Card), a MS (Memory Stick), a MMC (Multimedia Card), a SDC (Secure Digital Card) and a SMC (Smart Media Card).

3. The image retrieval and memory-accessing business card scanning device as in claim 1, further comprising:
a screen set in the top of housing to display the text images and pictures stored in the memory card;
a plurality of operation buttons set in the top of the housing for editing the text images and pictures stored in the memory card; and
a connecting cord.

4. The image retrieval and memory-accessing business card scanning device as in claim 3, wherein the screen is a light-emitting diode (LED) screen or a liquid crystal display (LCD) screen.

5. The image retrieval and memory-accessing business card scanning device as in claim 3, wherein the connecting cord is one of a USB connecting cord and an IEEE 1394 bus connecting cord.
